(19) United States
(12) Patent Application Publication
(10) Pub. No.: US 2011/0180083 A1
(43) Pub. Date: Jul. 28, 2011

(54) Cigarette Filter Cutting Element

(76) Inventors: John Major, Southampton (GB); Peter Rex White, Southampton (GB)

(21) Appl. No.: 13/003,285

(22) PCT Filed: Jun. 4, 2009
(86) PCT No.: PCT/EP09/56848

§ 371 Date: Apr. 7, 2011

(30) Foreign Application Priority Data
Jul. 14, 2008 (GB) 0812784.7

(51) Int. Cl. A24C 5/60; B26D 1/00

(52) U.S. Cl. 131/281; 493/45

(57) ABSTRACT

A cutting element (1) rotatably mountable in a cigarette manufacturing machine, or filter combining machine for cutting filter rods is disclosed. The cutting element comprises a circular blade (2) having apertures (4) therein configured so as to reduce the contact area between the blade and the ends of a filter rod during cutting.

The present invention relates to a cutting element or blade for cutting filter rods during the manufacture of cigarettes, or the combining of segmented filters.

A cigarette typically includes a tobacco rod formed from a charge of smoking material such as, for example, shredded tobacco. In a filter cigarette a filter element, composed of filter material such as cellulose acetate tow wrapped in a paper wrapper known as a plug wrap, is typically attached to one end of the tobacco rod by means of a wrapping or tipping material. A smoker ignites one end of the tobacco rod remote from the filter and draws smoke in through the filter. The filter traps some of the smoke products produced by burning the tobacco rod.

During cigarette manufacture, the filters are cut to individual cigarette length by a cutting element and it is conventional to use a circular cutting wheel or blade that is mounted for rotation on the cigarette maker tipping unit. During filter combining, the filter base rods are cut to individual segment length by a cutting element and it is conventional to use a circular cutting wheel or blade that is mounted for rotation on the filter combining machine.

The plug wrap is coated with adhesive so that it adheres to the cellulose acetate tow. However, it has been found that after a period of prolonged use a build-up of adhesive from the plug wrap occurs on the surfaces of the cutting element. This requires the machine to be stopped and the blade cleaned before the machine can be re-started.

It is known to provide the blade with a surface coating which resists build-up of adhesive. However, this is not particularly successful as the coating tends to wear after a period of time and so the blade must be replaced.

The present invention seeks to overcome or substantially alleviate the problems referred to above.

According to the present invention, there is provided a cutting element rotatably mountable in a cigarette manufacturing machine or filter combining machine for cutting filter rods, the cutting element comprising a circular blade having apertures therein configured so as to reduce the contact area between the blade and the ends of a filter rod during cutting.

Preferably, the blade has a peripheral cutting edge and an axis of rotation extending through a centre of the blade.

In a preferred embodiment, the blade has an opening coaxial with said axis for mounting the cutting element in a cutting machine.

In one embodiment, each aperture is spaced radially away from the axis of the blade and is located adjacent to the cutting edge.

In a preferred embodiment, each aperture is of the same size and shape and spaced from each other in a circumferential direction by the same distance. The blade may be symmetrical about its axis.

In one embodiment, each aperture may be circular. In another embodiment, each aperture may be in the form of an arcuate slot.

Embodiments of the invention will now be described, by way of example only, with reference to the accompanying drawings, in which:

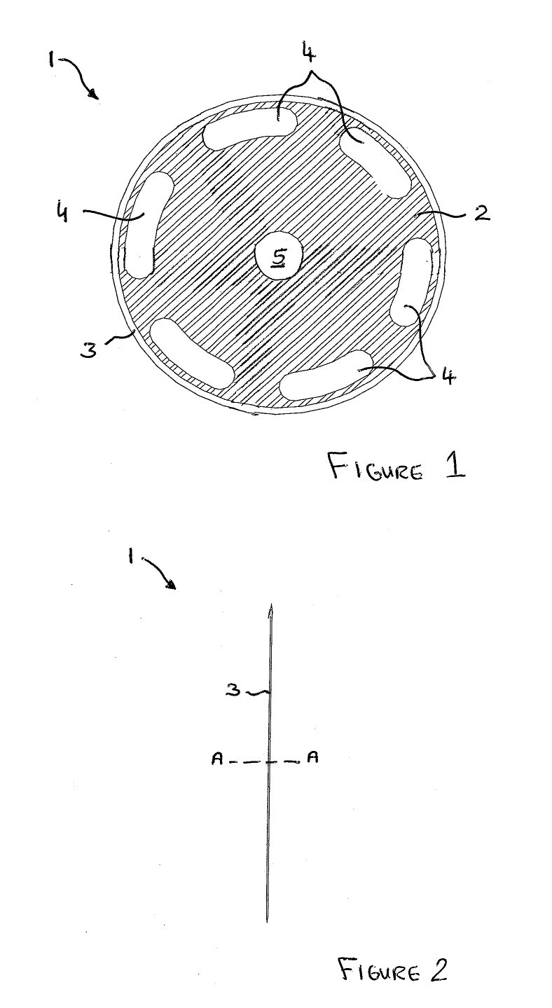

FIG. 1 is a plan view of looking at one surface of a cutting element according to an embodiment of the invention;

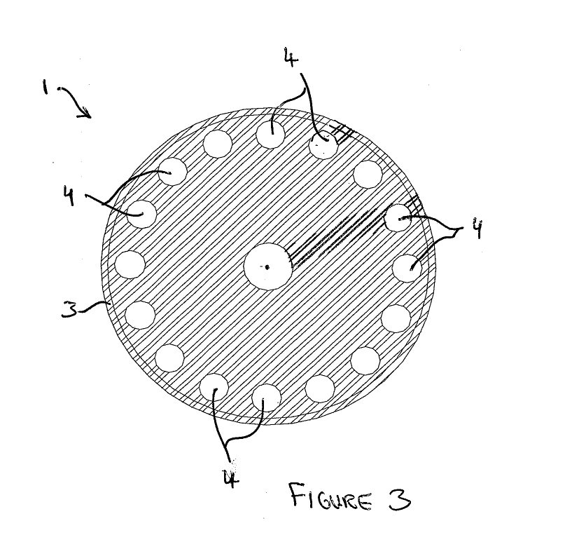

FIG. 2 is an edge side view of the cutting element shown in FIG. 1, and

FIG. 3 is a plan view looking at one face of a cutting element according to another embodiment.

Referring now to the drawings, there is shown in FIGS. 1 to 3 preferred embodiments of circular cutting element 1 according to the invention. The cutting element 1 is formed from tungsten carbide and comprises a blade 2 having a peripheral cutting edge 3.

The cutting element 1 is mounted in a filter combiner machine (not shown), or cigarette making machine for rotation about an axis A-A (see FIG. 2), so as to cut filter rods to desired length to form combined filter rods or for individual cigarettes. The blade 2 has a central opening or hole 3 to enable it to be mounted to a hub (not shown) on the filter combiner, or cigarette making machine.

The blade 2 has a plurality of apertures 4 (six in the embodiment of FIG. 1) which extend completely through the blade 2. The apertures are spaced radially away from the axis of rotation of the blade 2 and are close to the cutting edge 3. The distance of each aperture 4 from the cutting edge 3 is selected such that it is less than the diameter of the filter rod being cut so that the apertures 4 will pass between the cut end faces of the filter rod as the blade 1 rotates thereby reducing the contact area between the blade 1 and the filter rod and, consequently, the build-up of adhesive on the surfaces of the blade 1.

In the embodiment shown in FIG. 1, the apertures 4 are arcuate slots spaced evenly around the perimeter of the blade 1 adjacent to the cutting edge 3. However, in the embodiment of FIG. 3, the apertures 4 are circular. The blade 1 is preferably symmetrical about its axis of rotation A-A so that its axis of rotation extends through its centre of gravity. It will be appreciated that the apertures 4 may take any shape or form. However, it is envisaged that the apertures 4 will be shaped and sized so as to provide the maximum reduction in contact area between the body portion 2 of the blade 1 and the cut ends of the filter rods, without compromising the strength or rigidity of the blade 1.

Preferably, the blade 1 may have a maximum diameter of 100 mm and a thickness of 0.4 mm. The diameter of the central opening is approximately 15 mm. The radial distance between the axis of rotation A-A and the centre of an aperture 4 may be in the order of 41 mm. In the embodiment of FIG. 3, each aperture 4 may have a diameter of approximately 4.5 mm.

It will be appreciated that the foregoing description is given by way of example only and that modifications may be made to the cutting element of the present invention without departing from the scope of the appended claims.

1. A cigarette manufacturing machine or filter combining machine comprising:
a cutting element for cutting filter rods formed from filter material and plug wrap adhered to the filter material using adhesive, the cutting element including a circular blade having apertures therein configured to reduce the contact area between the blade and ends of the filter rods during cutting and thereby minimise the build up of adhesive on the cutting element.

2. The cigarette manufacturing machine or filter combining machine according to claim 1, wherein the blade has a peripheral cutting edge and an axis of rotation extending through a centre thereof.

3. The cigarette manufacturing machine or filter combining machine according to claim 2, wherein blade has an opening coaxial with said axis for mounting the cutting element in a cutting machine.

4. The cigarette manufacturing machine or filter combining machine according to claim 2, wherein each aperture is spaced radially away from the axis of the blade adjacent to the cutting edge.

5. The cigarette manufacturing machine or filter combining machine according to claim 4, wherein a centre of each aperture is situated radially away from the cutting edge a distance that is less than the diameter of a target filter rod engaged by the cutting element.

6. The cigarette manufacturing machine or filter combining machine according to claim 4, wherein each aperture is of the same size and shape and the apertures are evenly spaced from each other.

7. The cigarette manufacturing machine or filter combining machine according to claim 6, wherein the cutting element is symmetrical about its axis of rotation.

8. The cigarette manufacturing machine or filter combining machine according to claim 1, wherein each aperture is circular.

9. The cigarette manufacturing machine or filter combining machine according to claim 1, wherein each aperture is an arcuate slot.

10. (canceled)

11. A method of reducing the build-up of adhesive on a cutting element of a cigarette manufacturing machine or filter combining machine used to cut filter rods formed from filter material and plug wrap adhered to the filter material using adhesive, the cutting element comprising a circular blade, wherein the method includes:
providing apertures in the circular blade that are configured to reduce the contact area between the blade and ends of the filter rods during cutting such that the build-up of adhesive on the cutting element is minimized.

12. A cigarette manufacturing machine or filter combining machine, comprising:
a cutting element for cutting filter rods formed using adhesive, the cutting element including a circular blade having a plurality of apertures positioned towards the periphery of the blade and configured to pass over end faces of the filter rods cut by the cutting blade.
